(19) United States
(12) Patent Application Publication
(10) Pub. No.: US 2014/0108270 A1
(43) Pub. Date: Apr. 17, 2014

(54) ADDRESS-BASED CUSTOMER SERVICE

(71) Applicant: VERIZON PATENT AND LICENSING INC., Arlington, VA (US)

(72) Inventors: Vipul Jha, Irving, TX (US); Prakash Nallagatla, Plano, TX (US)

(73) Assignee: VERIZON PATENT AND LICENSING INC., Arlington, VA (US)

(21) Appl. No.: 13/652,782

(22) Filed: Oct. 16, 2012

(51) Int. Cl. G06Q 10/00

(52) U.S. Cl. 705/304

(57) ABSTRACT

A request is received for information relating to a service being provided to a customer premises. A network address of a device from which the request was received is determined. The network address is used to access customer data associated with the address. In addition to the requested information relating to the service, at least one notification is provided based on the customer data and including information relating to the customer premises, billing and payment information associated with the customer premises, a list of one or more equipment included in the customer premises, a list of one or more equipment suggested for the customer premises, and a list of one or more additional services suggested for the customer premises.

### BACKGROUND INFORMATION

Providing customer support is both important and expensive for service providers. It is important because good customer support builds customer loyalty and a good reputation. Poor customer support, on the other hand, can lead to customer frustrations and the loss of the customer's business. For example, customers visiting a website to resolve issues may become frustrated and inclined to switch service providers if answers to the customer's questions, or information sought by the customer, are difficult to obtain. Further, customer support can be expensive because identifying and responding to customer issues can be difficult and time-consuming. For example, providing a customer with one-on-one contact with a customer service representative, whether by text messaging, e-mail, or telephone, involves significant overhead. Unfortunately, it is often difficult to identify customers and customer issues, and to provide customers with appropriate information, thereby leading to customer frustration with service providers and increasing service provider costs.

### BRIEF DESCRIPTION OF THE DRAWINGS

FIG. 1 is a block diagram of an exemplary system for providing address-based customer service.

FIG. 2 illustrates an exemplary customer service graphical user interface.

FIG. 3 illustrates certain details of the exemplary customer service graphical user interface of FIG. 2.

FIG. 4 illustrates certain additional details of the exemplary customer service graphical user interface of FIG. 2.

FIG. 5 illustrates certain additional details of the exemplary customer service graphical user interface of FIG. 2.

FIG. 6 is a process flow diagram illustrating an exemplary notification process.

### DETAILED DESCRIPTION OF PREFERRED EMBODIMENTS

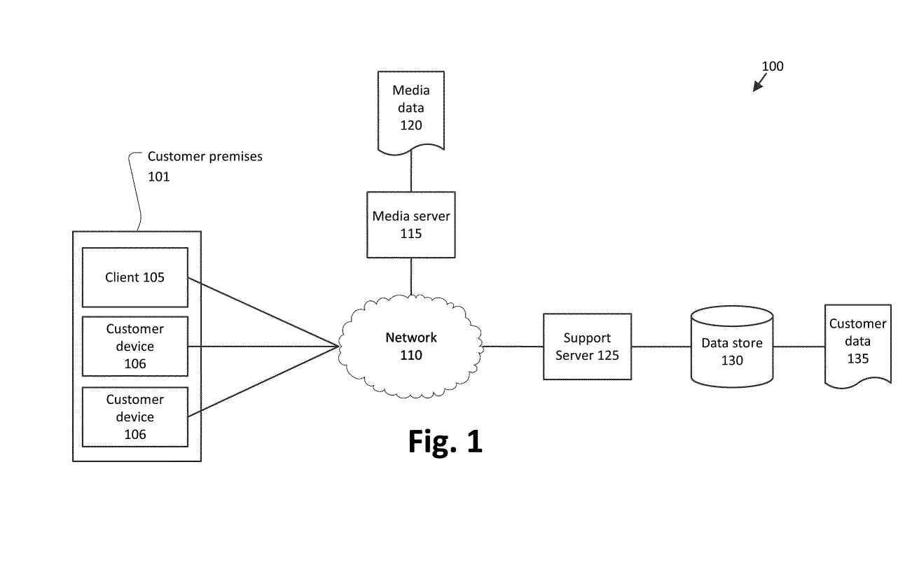

FIG. 1 is a block diagram of an exemplary system 100 for providing address-based customer service. The system 100 includes a customer premises 101, and generally includes a plurality of customer premises 101, although only one is shown in FIG. 1. The customer premises 101, which may receive various services, e.g., network services such as Internet services, media content delivery services, etc., in turn may include a client device 105 and/or one or more customer devices 106, each of which generally communicate, via at least one network 110, with a media server 115 that provides media data 120, and/or a support server 125. The support server 125 generally includes, or is communicatively coupled to, a data store 130 that stores customer data 135.

The customer premises 101 is generally a physical location to which media content and network services are provided. For example, the customer premises 101 may include a single-family home, a business location, an apartment or condominium, etc. Further, it is to be understood that “customer premises” as used herein includes mobile devices that may be used within or without the confines of boundaries of a physical location associated with a customer premises 101.

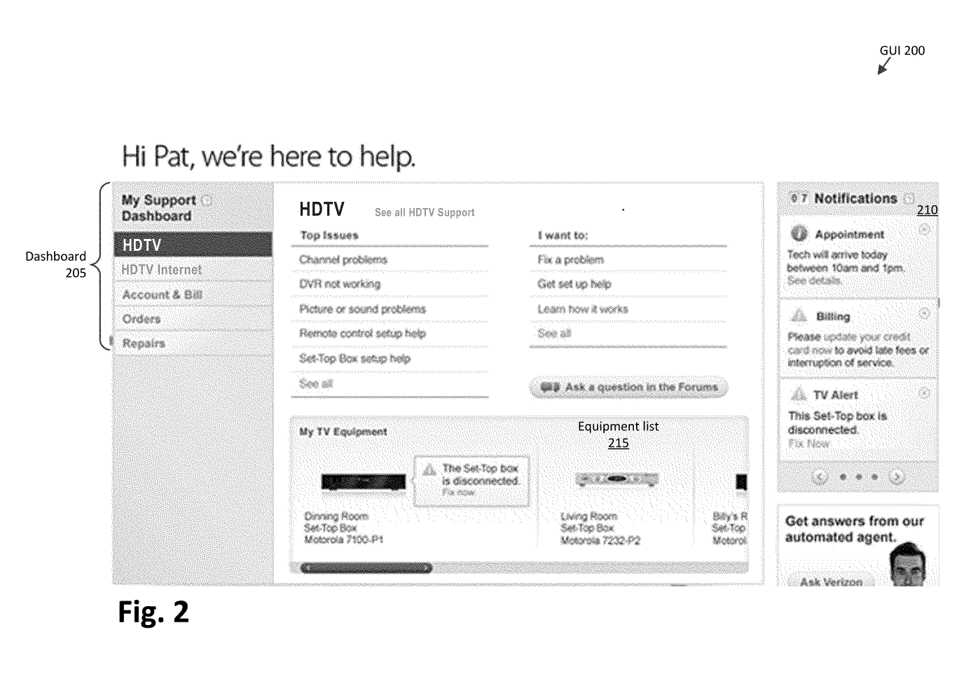

The client device 105 is generally a computing device that includes a processor and a memory, as well as a display that provides a graphical user interface (GUI), e.g., a GUI 200 as discussed below with respect to FIGS. 2-5. The client device 105 may request data from the support server 125, generally providing identifying information such as a network address along with such request for data. Further, the client device 105 may display media data 120 obtained from the media server 115, i.e., the client device 105 may perform operations similar to those of a customer media device 106.

The client 105 may be a single computing device, or one or multiple computing devices, and in any case at least has a processor for executing computer-executable instructions, and a memory and/or other computer readable media for storing data and computer-executable instructions. For example, client device 105 may be a smart phone, personal digital assistant, laptop computer, desktop computer, tablet computer, etc. Instructions included in computing device 105 may include instructions for displaying data in a GUI, e.g., as may be included in a standard web browser. Further, such instructions, e.g., as may be included in a client reporting application stored in client 105, may include instructions for requesting data, e.g., reports, and for otherwise communicating with the reporting server 115.

Customer media device 106, sometimes referred to as a content processing device, may be a set-top box (STB) or the like that receives a media signal from a network providing media programming, e.g., audio, video, etc., to a media playback device such as a television, computing device such as client 105, etc. For example, the device 106 may be manufactured by Motorola, Inc., of Schaumburg, Ill. The device 106 may be controlled by a user through an input device such as a keyboard, a remote control, etc., thereby facilitating the selection and playing of content through a playback device. Further, a device 106 may in some instances perform operations discussed herein with respect to the client 105.

The network 110 generally includes an internet protocol (IP) network. As such, network 110 generally uses one or more known protocols for transporting data, such as user datagram protocol (UDP), transport control protocol (TCP), hypertext transfer protocol (HTTP), etc. Further, network 110 may include a variety of networks such as a wide area network (WAN), e.g., the Internet, a local area network (LAN), etc. The network 110 may be used to transport a variety of data, including multimedia data such as audio data and video data provided from the media server 115. Such data can be transported via a packet network such as the Internet, or a specialized network for providing media transmissions, e.g., a video signal provided from the head end of a cable network. For example, network 110 may include hardware and software for providing a video signal via coaxial cable and/or fiber optic cable.

Server 115 is used for media content delivery and may provide media data 120 in a variety of formats, e.g., audio formats, video formats, etc. Further, although a single server 115 is depicted in FIG. 1, the system 100 may include a plurality of media servers 115. Further, the server 115 depicted in FIG. 1 may represent various media delivery mechanisms, e.g., a cable network head end, an Internet server, etc. The server 115 is generally, or generally includes, a computing device that includes a processor and a memory, the memory storing computer-executable instructions.

The support server 125, is generally, or generally includes, a computing device that includes a processor and a memory, the memory storing computer-executable instructions, may include web server software or the like for providing GUI 200, discussed below with respect to FIGS. 2-5. Further, the server 125 includes, and/or includes mechanisms for communicating with, a data store 130 that includes customer data 135. For example, the customer data 135 may include data associated with individual customers and/or customer premises 101, such as a network address, e.g., an IP address, associated with the customer and/or customer premises 101. Customer data 135 may also include data identifying services to which a customer premises 101 is subscribed, billing information, requests for support in the status thereof, repair requests and the status thereof, etc.

In general, support server 125 includes instructions for determining an identifier, e.g., an address such as an IP address, of a client device 105 requesting data, e.g., requesting the display of a support webpage including the GUI 200. The support server 125 may then use this identifier to access customer data 135 in the data store 130 that is associated with the identifier. Such data may then be provided to client 105 when client 105 accesses the support server 125. For example, client 105 may visit a service provider's general support webpage, whereupon the server 125 may provide personalized information, notifications, and/or suggestions, etc. based on determining the identifier associated with a client 105. Examples of information, etc., that may be so provided are discussed below with respect to GUI 200.

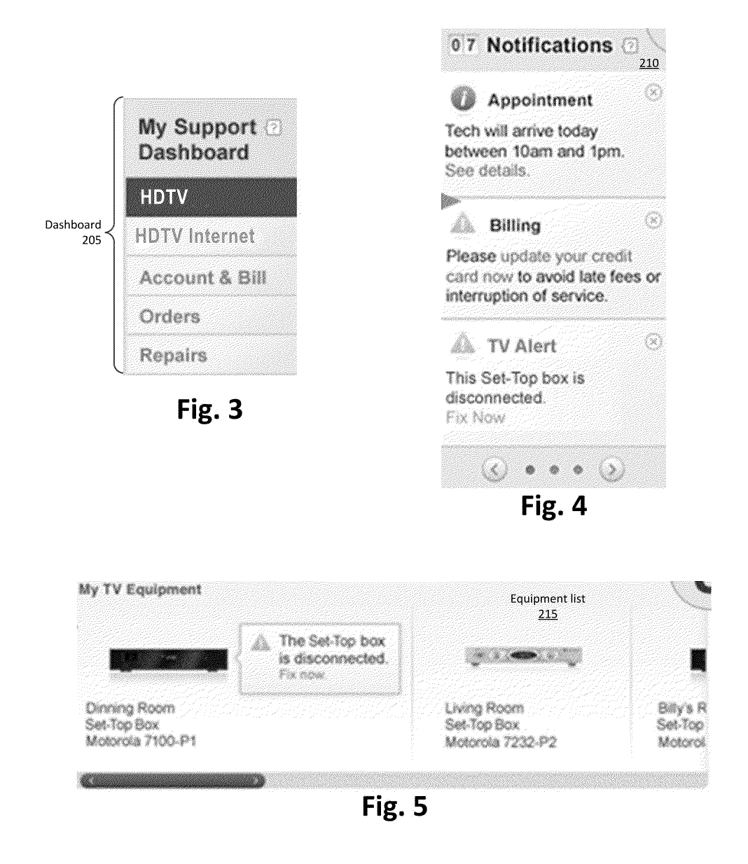

FIG. 2 illustrates an exemplary customer service graphical user interface (GUI) 200. In general, the GUI 200 may be personalized or customized, e.g., by proactively providing certain information to the customer via the GUI 200 as described herein, to enhance the provision of services to the customer, and to enhance the customer experience. The GUI 200 includes a support dashboard 205, an enlarged illustration of which is provided in FIG. 3, a notifications area 210, an enlarged illustration of which is provided in FIG. 4, and a customer equipment list 215, an enlarged illustration of which is provided in FIG. 5.

The support dashboard 205 generally lists categories of support that may be of interest for a particular customer, e.g., customized according to customer data 135 for a particular client 105 once the client identifier has been determined, although the support dashboard could also simply provide a single set of categories of support that is the same for all clients 105.

In any case, as seen in FIGS. 2 and 3, the dashboard 205 lists categories of service, e.g., TV and Internet services, that may be provided to a customer premises 101, along with categories of information that may be of interest to a user of a client 105, e.g., “Account & Bill,” “Orders,” and “Repairs.” Thus, in the example of FIGS. 2 and 3, a customer has subscribed to both TV and Internet service, which are displayed in dashboard 205 according to customer data 135 associated with an identifier for a client 105 that has been determined by the server 125. However, if a customer had subscribed only to Internet service, for example, then the dashboard 205 would list only the Internet service, and not TV. Likewise, “Orders” and “Repairs” could be listed only if orders and repairs, respectively, were indicated as pending in the customer data 135 associated with the client 105 identifier.

As seen in FIGS. 2 and 4, the notifications area 210 of the GUI 200 provides various notifications to a customer, the notifications having been determined based on a client 105 identifier. For example, notifications relating to pending orders, service and repair requests, billing, equipment status, etc. may be provided.

As seen in FIGS. 2 and 5, equipment list 215 provides a list of equipment, possibly also along with status information for at least some of the equipment, in a customer premises 101 associated with a client 105 identifier determined by the server 125. For example, equipment list 215 as depicted in FIGS. 2 and 5 includes a list of set-top boxes in a customer premises 101, along with status information for one of the set-top boxes that has been disconnected. Of course, other equipment, and other status information, could be included in the equipment list 215. Equipment list 215, or some other portion of the GUI 200, could, for example, include status information telling a customer that a particular piece of equipment, e.g., a set-top box, had ceased functioning or potentially would cease functioning so that the customer could check that piece of equipment. In such a manner the customer could proactively be provided with information relating to services provided to the customer, or that could be provided to the customer, and/or improving the customer's service experience.

Other customer-specific information could be provided in the GUI 200 based on a client 105 identifier. Customers could be provided with links to support pages most relevant to services to which they had subscribed and/or their particular equipment. For example, supposing that an identified customer premises 101 included a particular set-top-box with a known issue, the customer could be directed to a support page to address the issue via an alert provided in the GUI 200. Likewise, if a customer premises 101 included a known infrastructure issue, GUI 200 could include an offer to the customer to upgrade service, e.g., from copper wire to fiber-optic cable, to avoid the issue. This is another example of proactively providing information to improve or modify a customer's service or service experience.

Further, GUI 200 could be used to provide proactively to a customer information relating to account and payment issues upon determination of a client 105 identifier. For example, a customer could be alerted that the credit card was about to expire, that payment was delinquent, etc. Another example of using the GUI 200 to proactively provide customer information based on a client 105 identifier includes providing alerts related to services, e.g., relating to current or expected outages of media services for of utilities, e.g. electric, that could impact delivery of media services.

Customer data 135 that may be provided according to an associated client 105 identifier may be limited by regulatory, legal, privacy, etc., concerns. For example, customer data 135 may include customer proprietary network information (CPNI) that should not be provided to client 105 simply based on a network address or the like. Therefore, sensitive data such as CPNI may be filtered or excluded from customer data 135 included in the GUI 200. Additionally or alternatively, such sensitive data may be included in the GUI 200, even if based on a client 105 identifier, only after a user of the client 105 has completed a further authentication procedure, e.g., logging in with a username and password.

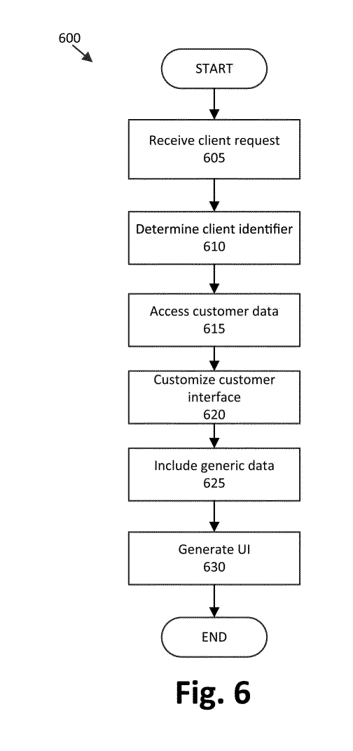

FIG. 6 is a process flow diagram illustrating an exemplary notification process 600.

The process 600 begins in a step 605, when the server 125 receives a request from a client 105 for information relating to network and/or media services, e.g., being provided to the customer premises 101. For example, as mentioned above, the client 105 could access a customer service or support webpage provided by the server 125.

Next, in a step 610, the server 125 determines an identifier, e.g., a network address, associated with the client 105 making the request received in step 605. Various mechanisms for determining an address such as an IP address are known and may be used. For example, the server 125 may belong to an Internet Service Provider (ISP) for the client 105. In that case, the server 125 or some other mechanism of the ISP may be used to identify customers based on the IP address of client 105. A change in a customer's service IP address is generally registered in the ISP's database. The server 125 may hash this IP address against this database to provide access to a customer's profile.

Next, in a step 615, the server 125 accesses customer data 135 according to the client 105 identifier determined in step 610. As mentioned above, various customer data 135 may be accessed, e.g., data relating to service subscriptions, billing and payment, pending orders, repairs, etc.

Next, in a step 620, the server 125 customizes the GUI 200 according to customer data 135 accessed in step 615. For example, server 125 may determine particular items to be included in the dashboard 205, the notifications area 210, the equipment list 215, etc. Further, other information, examples of which are provided above, may be included in the GUI 200 based on a client 105 identifier. As discussed above, the GUI 200 may be customized or personalized in a number of ways to enhance customer service and the customer experience. For example, information about the customer's service, equipment that may need servicing, services that could be provided to the customer, etc., could be provided according to customer data 135. For example, such information could be provided based on a customer's location, e.g., a customer could be searching for information relating to a service to which the customer presently subscribes, and the GUI 200 could present to the customer information about a new service to which the customer does not, but may wish to, subscribe, based on the availability of the service in the customer's location. Likewise, as illustrated in FIGS. 2 and 5, customer data 135 could be used to proactively provide the customer with information relating to the customer's equipment and/or to offer the customer additional equipment that may enhance the customer experience.

Next, in a step 625, server 125 may include within the GUI 200 generic information, i.e., information not determined according to customer data 135 based on a client 105 identifier.

Next, in a step 630, the server 125 generates, and provides to the client 105, the GUI 200. For example, as mentioned above, the GUI 200 may be a webpage or the like that is provided to and rendered in a standard web browser on the client 105.

Following step 630, the process 600 ends.

Computing devices such as client 105, media devices 106, server 115, server 120, etc., may employ any of a number of computer operating systems, including, but by no means limited to, versions and/or varieties of the Microsoft Windows® operating system, the iOS by Apple Computer, Inc., Android by Google, Inc., the Unix operating system (e.g., the Solaris® operating system distributed by Sun Microsystems of Menlo Park, Calif.), the AIX UNIX operating system distributed by International Business Machines (IBM) of Armonk, N.Y., and the Linux operating system. Computing devices in general may include any one of a number of computing devices, including, without limitation, a computer workstation, a desktop, notebook, laptop, or handheld computer, or some other computing device.

Computing devices such as those discussed herein generally each include instructions executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in a computing device is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases or data stores described herein, e.g., data stores 120, 135, etc., may include various kinds of mechanisms for storing, accessing, and retrieving various kinds of data, including a hierarchical database, a set of files in a file system, an application database in a proprietary format, a relational database management system (RDBMS), etc. Each such database or data store is generally included within a computing device employing a computer operating system such as one of those mentioned above, and are accessed via a network in any one or more of a variety of manners. A file system may be accessible from a computer operating system, and may include files stored in various formats. An RDBMS generally employs Structured Query Language (SQL) in addition to a language for creating, storing, editing, and executing stored procedures, such as the PL/SQL language mentioned above. Database 115 may be any of a variety of known RDBMS packages, including IBMS DB2, or the RDBMS provided by Oracle Corporation of Redwood Shores, Calif.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A method, comprising:
receiving a request for information relating to a service being provided to a customer premises;
determining a network address of a device from which the request was received;
using the network address to access customer data associated with the address; and
providing, in addition to the requested information relating to the service, at least one notification based on the customer data and including information relating to the customer premises, billing and payment information associated with the customer premises, a list of one or more equipment included in the customer premises, a list of one or more equipment suggested for the customer premises, and a list of one or more additional services suggested for the customer premises.

2. The method of claim 1, wherein the request for information is a request for a web page.

3. The method of claim 1, wherein the network address is an internet protocol (IP) address.

4. The method of claim 1, wherein the service is at least one of Internet service and a media content delivery service.

5. The method of claim 1, further comprising filtering the information to exclude information based on customer data that is sensitive.

6. The method of claim 1, the notification including links to information relevant to an issue indicated by the customer data.

7. A non-transitory computer-readable medium tangibly embodying computer-executable instructions, including instructions for:
determining a network address of a device from which the request was received;
using the network address to access customer data associated with the address; and
providing, in addition to the requested information relating to the service, at least one notification based on the customer data and including information relating to the customer premises, billing and payment information associated with the customer premises, a list of one or more equipment included in the customer premises, a list of one or more equipment suggested for the customer premises, and a list of one or more additional services suggested for the customer premises.

8. The medium of claim 7, wherein the request for information is a request for a web page.

9. The medium of claim 7, wherein the network address is an internet protocol (IP) address.

10. The medium of claim 7, wherein the service is at least one of Internet service and a media content delivery service.

11. The medium of claim 7, the instructions further comprising instructions for filtering the information to exclude information based on customer data that is sensitive.

12. The medium of claim 7, the notification including links to information relevant to an issue indicated by the customer data.

13. A system, comprising a server, the server being configured to:
receive a request for information relating to a service being provided to a customer premises;
determine a network address of a device from which the request was received;
use the network address to access customer data associated with the address; and
provide, in addition to the requested information relating to the service, at least one notification based on the customer data and including information relating to the customer premises, billing and payment information associated with the customer premises, a list of one or more equipment included in the customer premises, a list of one or more equipment suggested for the customer premises, and a list of one or more additional services suggested for the customer premises.

14. The system of claim 13, wherein the request for information is a request for a web page.

15. The system of claim 13, wherein the network address is an internet protocol (IP) address.

16. The system of claim 13, wherein the service is at least one of Internet service and a media content delivery service.

17. The system of claim 13, the server being further configured to filter the information to exclude information based on customer data that is sensitive.

18. The system of claim 13, the notification including links to information relevant to an issue indicated by the customer data.
